(19) United States
(12) Patent Application Publication
(10) Pub. No.: US 2026/0223036 A1
(43) Pub. Date: Jul. 30, 2026

(54) TECHNIQUES FOR DECODING PAGING FOR MILLIMETER WAVE CAPABLE USER EQUIPMENT

(71) Applicant: QUALCOMM Incorporated, San Diego, CA (US)

(72) Inventors: Ansah Ahmed SHEIK, Hyderabad (IN); Arvind Vardarajan SANTHANAM, San Diego, CA (US); Ling XIE, Beijing (CN); Rishika TINDOLA, Hyderabad (IN)

(21) Appl. No.: 19/158,239

(22) PCT Filed: Apr. 27, 2023
(86) PCT No.: PCT/CN2023/091106

§ 371 Date: Aug. 20, 2025

(51) Int. Cl. H04W 60/04; H04W 8/20; H04W 68/02

(52) U.S. Cl. CPC H04W 60/04; H04W 8/20; H04W 68/02

(57) ABSTRACT

Various aspects of the present disclosure generally relate to wireless communication. In some aspects, a user equipment (UE) may register on a first cell, in a first frequency range, associated with a first subscription of the UE. The UE may register on a second cell, in a second frequency range, associated with a second subscription of the UE. The UE may receive, on the first cell and via the first subscription, a paging message associated with the second subscription. The UE may decode the paging message. Numerous other aspects are described.

### FIELD OF THE DISCLOSURE

Aspects of the present disclosure generally relate to wireless communication and to techniques and apparatuses for decoding paging for millimeter wave capable user equipment.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include registering on a first cell, in a first frequency range, associated with a first subscription of the UE. The method may include registering on a second cell, in a second frequency range, associated with a second subscription of the UE. The method may include receiving, on the first cell and via the first subscription, a paging message associated with the second subscription. The method may include decoding the paging message.

Some aspects described herein relate to a method of wireless communication performed by a UE. The method may include registering on a first cell in a first frequency range. The method may include receiving, on the first cell, a paging message associated with a second cell and a second frequency range different from the first frequency range. The method may include decoding the paging message.

Some aspects described herein relate to a UE for wireless communication. The UE may include a memory and one or more processors coupled to the memory. The one or more processors may be configured to register on a first cell, in a first frequency range, associated with a first subscription of the UE. The one or more processors may be configured to register on a second cell, in a second frequency range, associated with a second subscription of the UE. The one or more processors may be configured to receive, on the first cell and via the first subscription, a paging message associated with the second subscription. The one or more processors may be configured to decode the paging message.

Some aspects described herein relate to a UE for wireless communication. The UE may include a memory and one or more processors coupled to the memory. The one or more processors may be configured to register on a first cell in a first frequency range. The one or more processors may be configured to receive, on the first cell, a paging message associated with a second cell and a second frequency range different from the first frequency range. The one or more processors may be configured to decode the paging message.

Some aspects described herein relate to a non-transitory computer-readable medium that stores a set of instructions for wireless communication by a UE. The set of instructions, when executed by one or more processors of the UE, may cause the UE to register on a first cell, in a first frequency range, associated with a first subscription of the UE. The set of instructions, when executed by one or more processors of the UE, may cause the UE to register on a second cell, in a second frequency range, associated with a second subscription of the UE. The set of instructions, when executed by one or more processors of the UE, may cause the UE to receive, on the first cell and via the first subscription, a paging message associated with the second subscription. The set of instructions, when executed by one or more processors of the UE, may cause the UE to decode the paging message.

Some aspects described herein relate to a non-transitory computer-readable medium that stores a set of instructions for wireless communication. The set of instructions, when executed by one or more processors of a UE, may cause the one or more processors to register on a first cell in a first frequency range. The set of instructions, when executed by one or more processors of a UE, may cause the one or more processors to receive, on the first cell, a paging message associated with a second cell and a second frequency range different from the first frequency range. The set of instructions, when executed by one or more processors of a UE, may cause the one or more processors to decode the paging message.

Some aspects described herein relate to an apparatus for wireless communication. The apparatus may include means for registering on a first cell, in a first frequency range, associated with a first subscription of the apparatus. The apparatus may include means for registering on a second cell, in a second frequency range, associated with a second subscription of the apparatus. The apparatus may include means for receiving, on the first cell and via the first subscription, a paging message associated with the second subscription. The apparatus may include means for decoding the paging message.

Some aspects described herein relate to an apparatus for wireless communication. The apparatus may include means for registering on a first cell in a first frequency range. The apparatus may include means for receiving, on the first cell, a paging message associated with a second cell and a second frequency range different from the first frequency range. The apparatus may include means for decoding the paging message.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of a multiple subscriber identity module UE, in accordance with the present disclosure.

FIG. 5 is a diagram illustrating an example of paging of cells belonging to different tracking area identifier lists, in accordance with the present disclosure.

FIG. 6 is a diagram illustrating an example of paging involving different tracking area identity (TAI) lists that identify the same tracking area code or TAI, in accordance with the present disclosure.

FIG. 7 is a diagram illustrating an example of reselecting from a first cell to a second cell to facilitate decoding of a paging message, for a second subscription (SUB), as received by a first SUB, in accordance with the present disclosure.

FIG. 8 is a diagram illustrating another example of reselecting from a first cell to a second cell to facilitate decoding of a paging message, directed to a second SUB, as received by a first SUB, in accordance with the present disclosure.

FIG. 9 is a diagram illustrating an example of decoding paging for a first SUB and a second SUB associated with a same frequency range, in accordance with the present disclosure.

FIG. 10 is a diagram illustrating an example of signaling associated with decoding paging across multiple SUBs, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram of an example apparatus for wireless communication, in accordance with the present disclosure.

### DETAILED DESCRIPTION

A user equipment (UE) may communicate in multiple frequency ranges (FRs), such as FR1 (e.g., sub-6 GHz communication) and FR2 (e.g., mm Wave communication). In some examples, a UE may include multiple subscriptions (SUBs), referred to as multiple subscriber identity module (SIM) (MSIM) operation. Each SUB may be capable of communicating with a radio access network. In some examples, a first SUB (e.g., SUB1, a default data subscriber (DDS) SUB) may be associated with a first FR (e.g., FR1) and a second SUB (e.g., SUB2, a non-DDS (NDDS) SUB) may be associated with a second FR. Beam management in some FRs, such as FR2, may lead to higher power consumption than operating in other FRs, such as FR1.

In the case of MSIM, in which SUB1 may be on FR1 and SUB2 may be on FR2, the UE may perform a radio frequency (RF) tuning operation to perform measurements and page decoding for each of the two SUBs. The measurement and page decoding in FR2 may increase UE power consumption, compared to measurement or page decoding in only FRI and/or other technologies, due to the higher frequency range. Thus, in FR1+FR2 MSIM, power consumption is higher, as each of the SUBs may measure serving and neighbor cells independently of one another.

Various aspects described herein relate generally to wireless communication. Some aspects more specifically relate to decoding of paging in MSIM. In some examples, the UE may decode, by a first SUB of a UE that is registered on a cell in a first FR (e.g., FR1), of a paging message associated with a second SUB of the UE. For example, the second SUB may be registered on a cell in a second FR. Some techniques described herein provide reselection, by the first SUB or the second SUB, to a different cell if a current registered cell of the first SUB and a current registered cell of the second SUB cannot share paging. For example, the first SUB or the second SUB may reselect to a cell that has a tracking area code that is identified by a tracking area identity list of the other SUB.

Particular aspects of the subject matter described in this disclosure can be implemented to realize one or more of the following potential advantages. By decoding the paging message associated with the second SUB, the UE avoids RF tuning and measurement in the second FR, which may be associated with higher power consumption than the first FR (e.g., if the second FR is FR2 and the first FR is FR1). By reselecting to a different cell if a currently registered cell cannot share paging, page sharing is enabled for such situations, further decreasing power consumption and increasing flexibility of MSIM communication.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

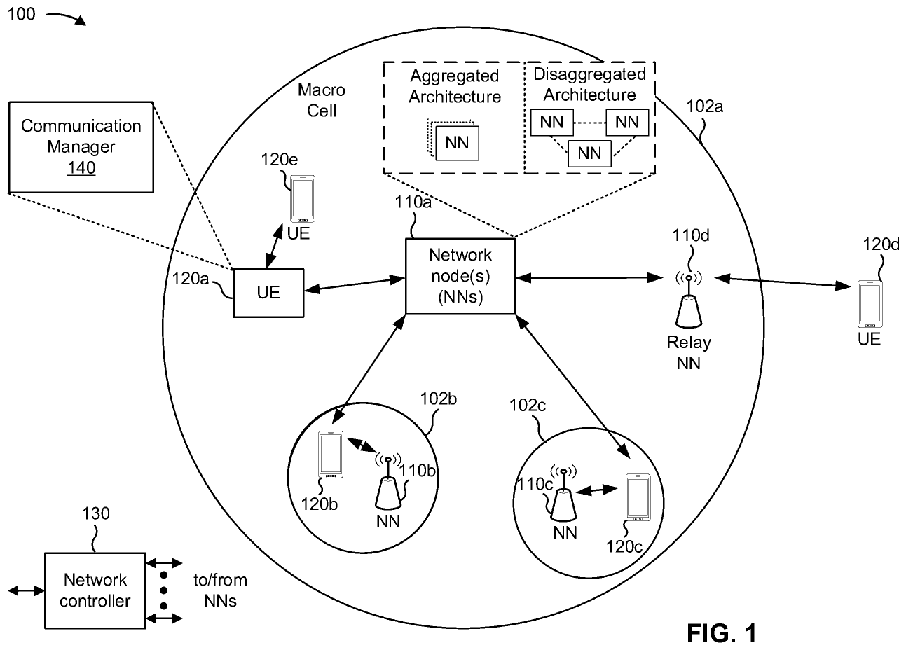

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IOT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may register on a first cell, in a first frequency range, associated with a first subscription of the UE; register on a second cell, in a second frequency range, associated with a second subscription of the UE; receive, on the first cell and via the first subscription, a paging message associated with the second subscription; and decode the paging message.

In some aspects, the communication manager 140 may register on a first cell in a first frequency range; receive, on the first cell, a paging message associated with a second cell and a second frequency range different from the first frequency range; and decode the paging message. Additionally, or alternatively, the communication manager 140 may perform one or more other operations described herein.

As indicated above, FIG. 1 is provided as an example. Other examples may differ from what is described with regard to FIG. 1.

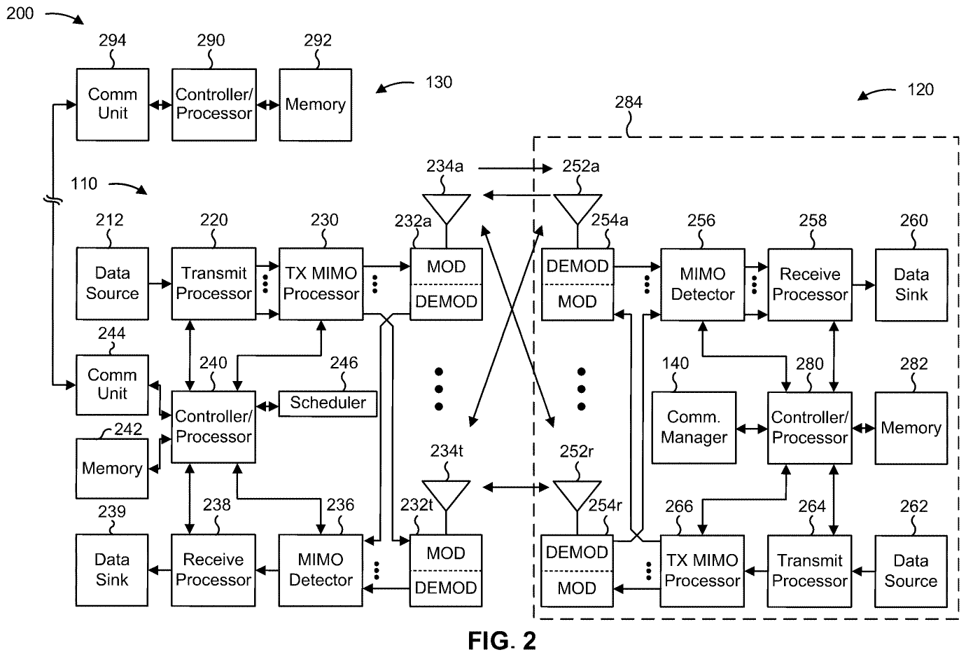

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252 a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, Toutput symbol streams) to a corresponding set of modems 232 (for example, Tmodems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

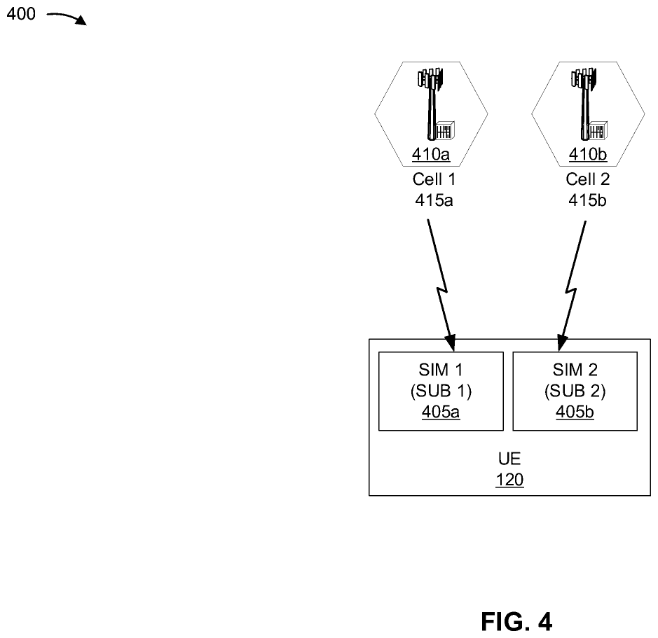

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-13).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-13).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

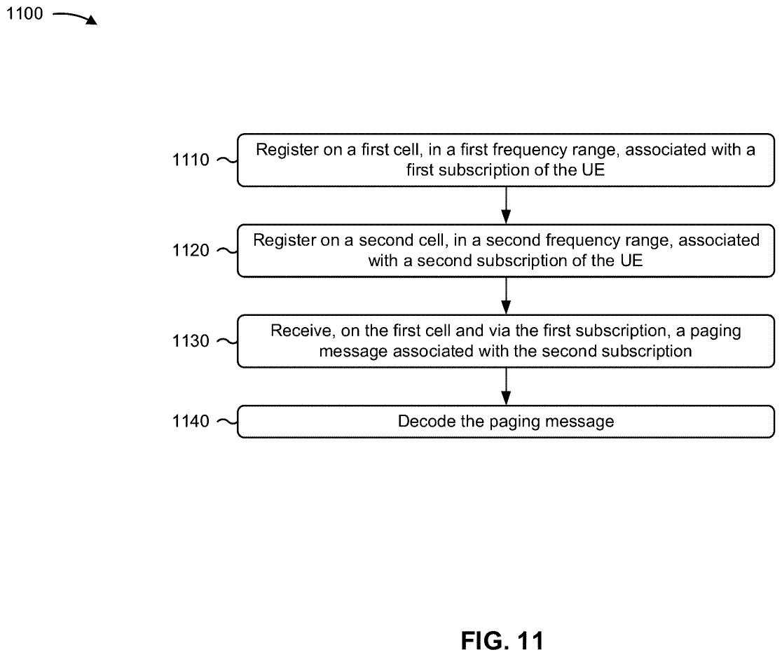

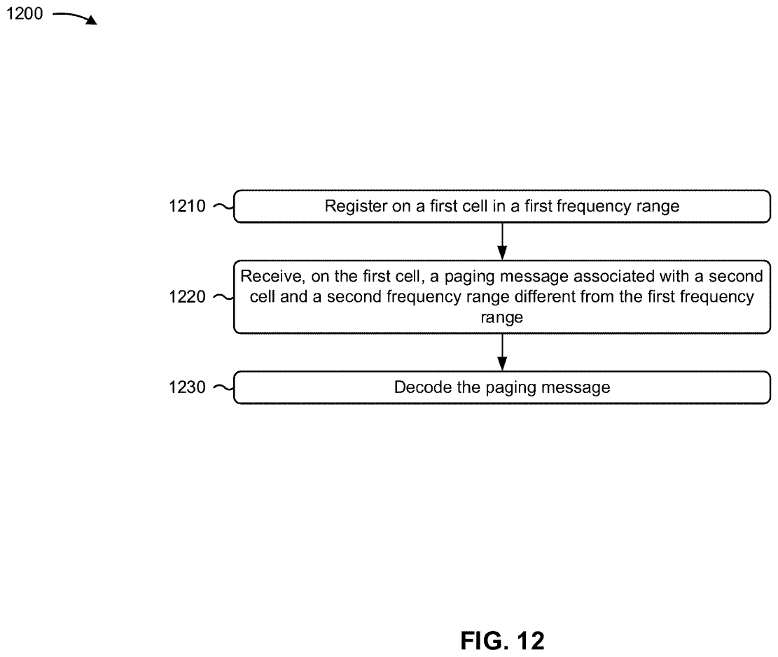

The controller/processor 240 of the network node 110, the controller/processor 280 of the UE 120, or any other component(s) of FIG. 2 may perform one or more techniques associated with MSIM paging, as described in more detail elsewhere herein. For example, the controller/processor 240 of the network node 110, the controller/processor 280 of the UE 120, or any other component(s) (or combinations of components) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication.

For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for registering on a first cell, in a first frequency range, associated with a first subscription of the UE 120; means for registering on a second cell, in a second frequency range, associated with a second subscription of the UE; means for receiving, on the first cell and via the first subscription, a paging message associated with the second subscription; and/or means for decoding the paging message. In some aspects, the UE 120 includes means for registering on a first cell in a first frequency range; means for receiving, on the first cell, a paging message associated with a second cell and a second frequency range different from the first frequency range; and/or means for decoding the paging message. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

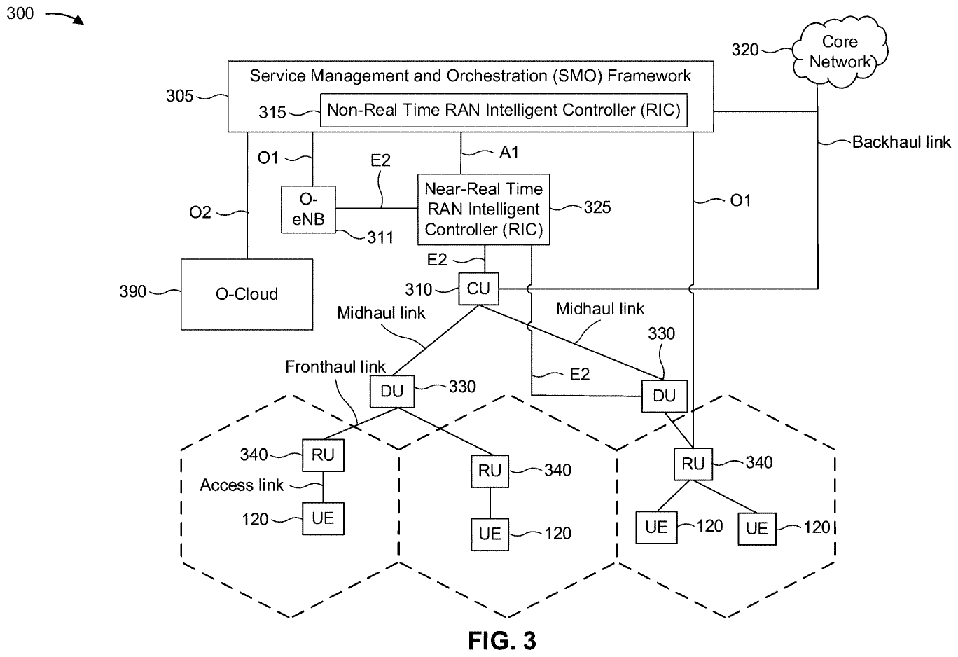

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

FIG. 4 is a diagram illustrating an example 400 of a multi-subscriber identity module (SIM) UE, in accordance with the present disclosure. As shown in FIG. 4, a UE 120 may be a multiple SIM (multi-SIM) UE that includes multiple SIMs (two or more SIMs), shown as a first SIM 405a and a second SIM 405b. The first SIM 405a may be associated with a first subscription (shown as SUB 1), and the second SIM 405b may be associated with a second subscription (shown as SUB 2). A subscription may be a subscription with a network operator (for example, a mobile network operator (MNO)) that enables the UE 120 to access a wireless network (for example, a radio access network (RAN)) associated with the network operator.

A SIM 405 may be a removable SIM (for example, a SIM card) or an embedded SIM. A SIM 405 may include an integrated circuit that securely stores an international mobile subscriber identity (IMSI) and a security key, which are used to identify and authenticate a corresponding subscription associated with the SIM 405. In some cases, a SIM 405 may store a list of services that the UE 120 has permission to access using a subscription associated with the SIM 405, such as a data service or a voice service, among other examples.

As further shown in FIG. 4, the UE 120 may communicate (for example, in a connected mode, an idle mode, or an inactive mode) with a first network node 410a via a first cell 415a (shown as Cell 1) using the first SIM 405a. In this case, a first subscription (SUB 1) of the UE 120 may be used to access the first cell 415a (for example, using a first IMSI for UE identification, using a first security key for UE authentication, using a first list of services that the UE 120 is permitted to access using the first subscription, or by counting data or voice usage on the first cell against the first subscription, among other examples). Similarly, the UE 120 may communicate (for example, in a connected mode, an idle mode, or an inactive mode) with a second network node 410b via a second cell 415b (shown as Cell 2) using the second SIM 405b. In this case, a second subscription (SUB 2) of the UE 120 may be used to access the second cell 415b (for example, using a second IMSI for UE identification, using a second security key for UE authentication, using a second list of services that the UE 120 is permitted to access using the second subscription, or by counting data or voice usage on the second cell against the second subscription, among other examples).

The first network node 410a and/or the second network node 410b may include one or more of the network nodes 110 described above in connection with FIG. 1. Although the first cell 415a and the second cell 415b are shown as being provided by different network nodes, in some aspects, the first cell 415 and the second cell 415b may be provided by the same network node. Thus, in some aspects, the first network node 410a and the second network node 410b may be integrated into a single network node.

In some cases, the UE 120 may be capable of operating in a multi-SIM multiple standby (MSMS) mode, such as a dual SIM dual standby (DSDS) mode (e.g., when the UE 120 is associated with two subscriptions). Additionally, or alternatively, the UE 120 may be capable of operating in a multi-SIM multiple active (SR-MSMA) mode, such as a dual SIM dual active (DSDA) mode (e.g., when the UE 120 is associated with two subscriptions).

In a DSDA mode, the UE 120 is capable of concurrent active communication using both SIMs of the UE 120. Thus, a UE 120 in the DSDA mode is capable of communicating using the first SIM 305a (and the first subscription) at the same time as communicating using the second SIM 305b (and the second subscription). For example, when the UE 120 is in an active session (e.g., a voice call or another latency sensitive service, such as online gaming, stock trading, or an over-the-top (OTT) service) using the first SIM 305a, the UE 120 is capable of receiving a notification of a voice call using the second SIM 305b without interrupting communications that use the first SIM 305a, and without tuning or switching away from the first cell 315a to tune to the second cell 315b.

In a DSDS mode, the UE 120 is not capable of concurrent active communication using both SIMs of the UE 120. Thus, a UE 120 in the DSDS mode is not capable of communicating using the first SIM 305a (and the first subscription) at the same time as communicating using the second SIM 305b (and the second subscription). However, a UE 120 in the DSDS mode may be capable of switching between two separate mobile network services, may include hardware for maintaining multiple connections (for example, one connection per SIM) in a standby state, or may include hardware (for example, multiple transceivers) for maintaining multiple network connections at the same time, among other examples. However, a UE 120 in the DSDS mode may be capable of receiving data on only one connection at a time because radio frequency resources are shared between the multiple subscriptions. For example, a UE 120 in the DSDS mode may be associated with multiple subscriptions but may include only a single transceiver shared by the multiple subscriptions, a single transmit chain shared by the multiple subscriptions, or a single receive chain shared by the multiple subscriptions, among other examples.

In some examples, a UE 120 may be capable of operating in a DSDA mode for a first combination of RATs, and may not be capable of operating in a DSDA mode for a second combination of RATs. For example, the UE 120 may be capable of operating in a DSDA mode for NR+NR, where the first cell 315a (as well as the first SIM 305a and the first subscription) uses an NR RAT and the second cell 315b (as well as the second SIM 305b and the second subscription) also uses the NR RAT. However, the UE 120 may not be capable of operating in a DSDA mode for NR+LTE, where one of the first cell 315a (as well as the first SIM 305a and the first subscription) uses an NR RAT and the second cell 315b (as well as the second SIM 305b and the second subscription) uses an LTE RAT (or vice versa). In some aspects, the UE 120 may not be capable of operating in the DSDA mode for the second combination of RATs (e.g., NR+LTE), but be capable of operating in a DSDS mode for the second combination of RATs. This UE design reduces design costs as compared to enabling the UE 120 to operate using the DSDA mode for the second combination of RATs.

In some aspects, a first SUB may operate in a first frequency range (such as FR1) and a second SUB may operate in a second frequency range (such as FR2). For example, the first cell 315a may be an FRI cell and the second cell 315b may be an FR2 cell. In some examples, the first SUB may be camped on the first cell 315a and the second SUB may be camped on the second cell 315b. UEs 120 may “camp on” a cell of a wireless communication system and silently rely on periodic broadcasting of signals, such as SIBs and synchronization signal blocks (SSBs), without a network node associated with the cell being aware of the camping UE. “Camping” on a cell or network node may refer to a UE monitoring broadcasts from a cell (for example, monitoring a control channel associated with the cell or the network node) to maintain readiness to actively connect with the cell or network node and utilize the wireless communication system.

As indicated above, FIG. 4 is provided as an example. Other examples may differ from what is described with regard to FIG. 4.

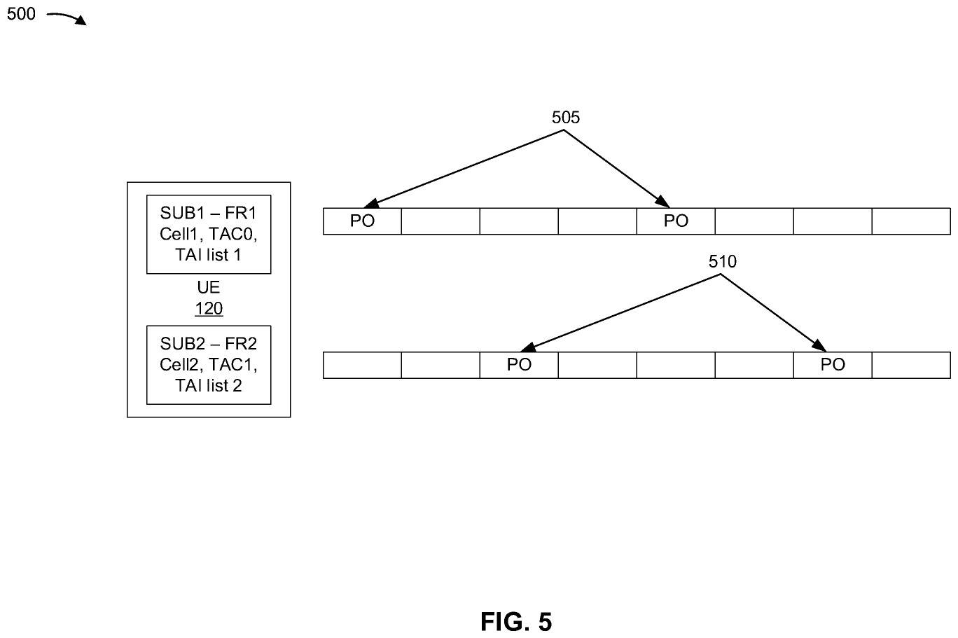

FIG. 5 is a diagram illustrating an example 500 of paging of cells belonging to different tracking area identifier lists, in accordance with the present disclosure. In example 500, a first SUB (SUB1) is camped on cell1. Celll is associated with a first tracking area code (TACO) which is included in a first tracking area identity (TAI) list (TAI list 1). In example 500, a second SUB (SUB2) is camped on cell2. Cell2 is associated with a second tracking area code (TAC1) which is included in a second TAI list (TAI list 2). For example, TACO is not included in the first TAI list and TAC1 is not included in the second TAI list. For example, cell1 is in FR1 and cell2 is in FR2.

Paging occasions (POs) for cell1 are shown by reference number 505. As shown, the POs occur periodically on the cell1. The UE may monitor for paging messages pertaining to the first TAI list on the POs of cell1. POs for cell2 are shown by reference number 510. As shown, the POs occur periodically on the cell2. The UE may monitor for paging messages pertaining to the second TAI list on the POs of cell2.

A TAI list may indicate a set of TAIs to which a paging message is to be distributed. A TAI may indicate a mobile country code (MCC), a mobile network code (MNC) and a tracking area code (TAC). A TAC is an identifier of a tracking area, and is unique within a public land mobile network. A TAI globally identifies a tracking area by including the MCC and the MNC.

A paging message may be directed to a TAI list. For example, if the paging message is directed to TAI list 1, network nodes may transmit the paging message on each cell having a TAC included in a TAI listed in TAI list 1. If the paging message is directed to TAI list 2, network nodes may transmit the paging message on each cell having a TAC included in a TAI listed in TAI list 2. A TAI can be included in multiple TAI lists. A TAC can be included in multiple TAI lists. If a TAC or TAI corresponding to a cell is included in multiple TAI lists, then paging for all of these TAI lists may be transmitted via the cell.

As indicated above, FIG. 5 is provided as an example. Other examples may differ from what is described with regard to FIG. 5.

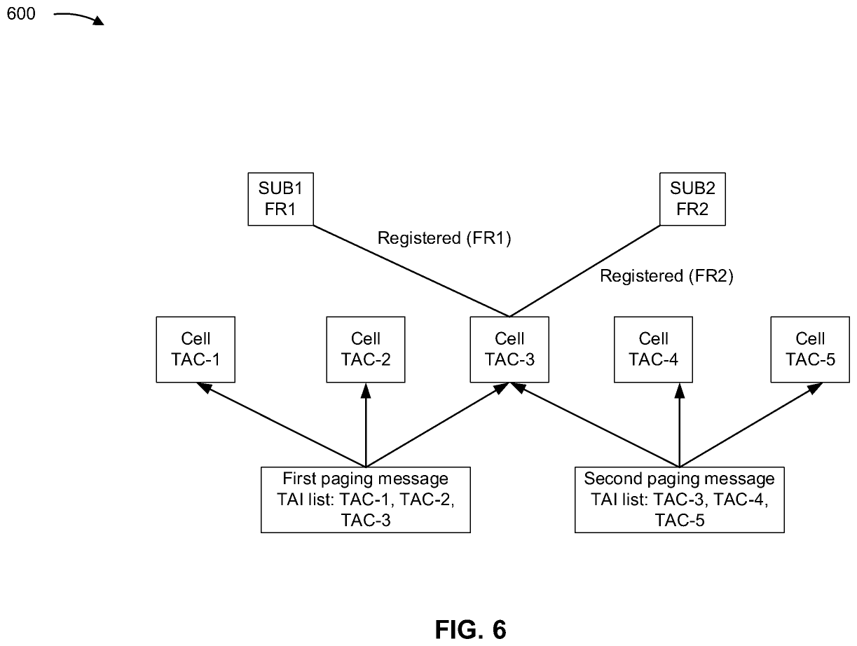

FIG. 6 is a diagram illustrating an example 600 of paging involving different TAI lists that identify the same TAC or TAI, in accordance with the present disclosure. As shown, example 600 includes SUB1 and SUB2. SUB1 is camped on a cell having a TAC of TAC-3 in FR1, and SUB2 is camped on the cell having the TAC of TAC-3 in FR2.

As shown, a first paging message may indicate a first TAI list including TAC-1, TAC-2, and TAC-3. In this example, network nodes may transmit the paging message on cells having TAC-1, TAC-2, and TAC-3. As further shown, a second paging message may indicate a second TAI list including TAC-3, TAC-4, and TAC-5. Note that the second TAI list and the first TAI list both include TAC-3. Therefore, network nodes may transmit the second paging message on cells having TAC-3, TAC-4, and TAC-5. Therefore, the first paging message and the second paging message are both transmitted on the cell having TAC-3. Thus, the UE can decode the second paging message (which is intended for SUB2) as received via the FR1 cell without retuning away from the FR1 cell or interrupting measurement in FR1.

As indicated above, FIG. 6 is provided as an example. Other examples may differ from what is described with regard to FIG. 6.

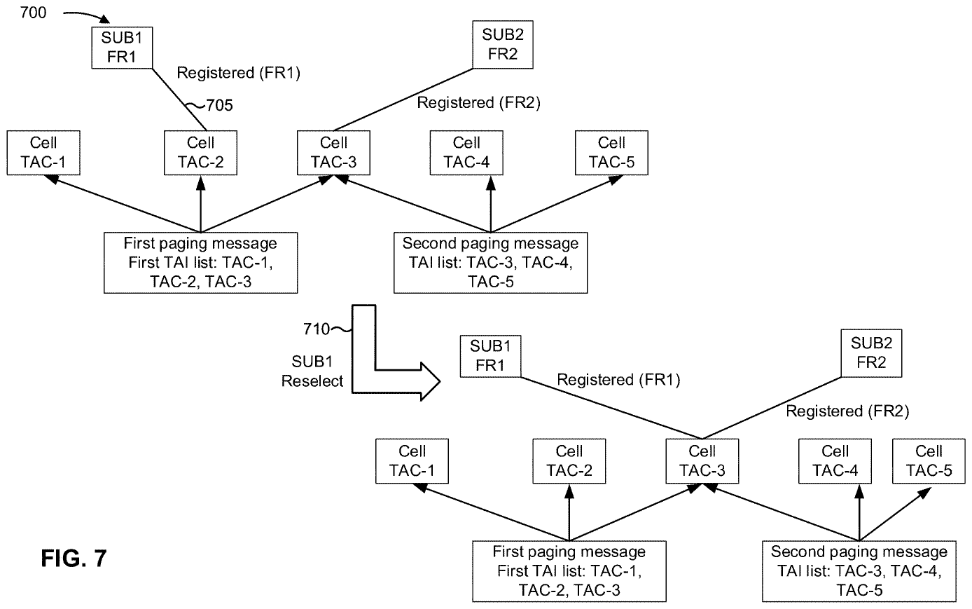

FIG. 7 is a diagram illustrating an example 700 of reselecting from a first cell to a second cell to facilitate decoding of a paging message, for a second SUB, as received by a first SUB, in accordance with the present disclosure. As shown, example 700 includes SUB1 and SUB2. SUB1 is initially camped or registered on a cell having a TAC of TAC-2 in FR1, as shown by reference number 705. SUB2 is initially camped or registered on a cell having the TAC of TAC-3 in FR2. As shown, a first TAI list may include TAC-1, TAC-2, and TAC-3. In this example, network nodes may transmit the paging message on cells having TAC-1, TAC-2, and TAC-3. As further shown, a second TAI list may include TAC-3, TAC-4, and TAC-5. Note that the second TAI list and the first TAI list both include TAC-3, but the second TAI list does not include TAC-2. Therefore, a paging message directed to the second TAI list may be delivered on the cell with TAC-3, but not the cell with TAC-2.

As shown by reference number 710, the UE may reselect, at SUB1, from the cell with TAC-2 to the cell with TAC-3. Thus, the UE may reselect to the cell that is identified by both the first TAI list and the second TAI list. In this way, the UE (e.g., SUB1) can receive a second paging message directed to the second TAI list on a cell in FR1 via SUB1, enabling the UE to decode the second paging message (which is intended for SUB2) as received via the FR1 cell without retuning away from the FR1 cell or interrupting measurement in FR1. In some aspects, the UE may perform this reselection based at least in part on a stored database. For example, the database may indicate TAI lists and cells having TACs or TAIs identified by the TAI lists. The UE may use this database to identify a TAC (in this example, TAC-3) that is shared between the first TAI list and the second TAI list, and that is in FR1. In some aspects, the UE may perform the cell reselection based at least in part on a threshold. For example, the UE may perform the cell reselection to the cell having TAC-3 if a measurement (e.g., a reference signal received power (RSRP)) of the cell satisfies a threshold (which may be configurable, and which may have a default value of, for example, −110 dBm), and if the cell is suitable for camping. A cell may be considered suitable for camping if the cell is part of a selected public land mobile network (PLMN), a registered PLMN, or a PLMN of an equivalent PLMN list, the cell is not barred, the cell is part of a tracking area that is not forbidden for roaming, and cell selection criteria are fulfilled.

As indicated above, FIG. 7 is provided as an example. Other examples may differ from what is described with regard to FIG. 7.

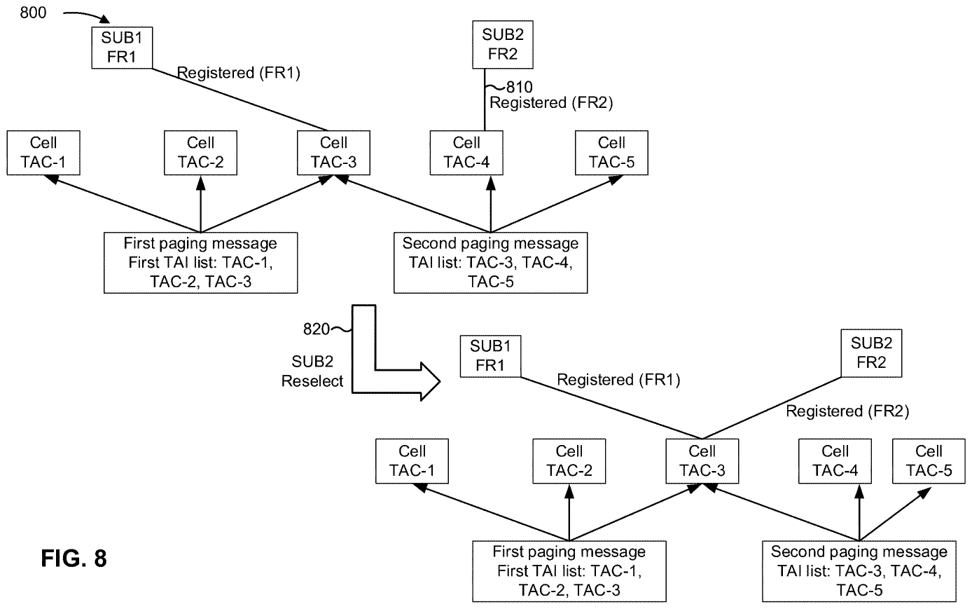

FIG. 8 is a diagram illustrating another example 800 of reselecting from a first cell to a second cell to facilitate decoding of a paging message, directed to a second SUB, as received by a first SUB, in accordance with the present disclosure. As shown, example 800 includes SUB1 and SUB2. SUB1 is initially camped or registered on a cell having a TAC of TAC-3 in FR1. SUB2 is initially camped or registered on a cell having the TAC of TAC-4 in FR2, as shown by reference number 810. As shown, a first TAI list may include TAC-1, TAC-2, and TAC-3. In this example, network nodes may transmit the paging message on cells having TAC-1, TAC-2, and TAC-3. As further shown, a second TAI list may include TAC-3, TAC-4, and TAC-5. Note that the second TAI list and the first TAI list both include TAC-3, but the first TAI list does not include TAC-4.

As shown by reference number 820, in some aspects, the UE may reselect, at SUB2, from a first cell to a second cell. For example, SUB2 may reselect if SUB1 cannot identify a suitable cell that is identified by the second TAI list (as described with regard to FIG. 7). In this example, SUB2 may reselect from the cell having TAC-4 to a cell having a TAC, in FR1, that is identified by the second TAI list and on which SUB1 is camped. For example, SUB2 may refer to a database indicating TACs in FR1 that are identified by the second TAI list. In this example, SUB2 may reselect to the cell having TAC-3. In some aspects, the UE may perform this reselection based at least in part on a stored database. For example, the database may indicate TAI lists and cells having TACs or TAIs identified by the TAI lists. The UE may use this database to identify a TAC (in this example, TAC-3) that is in the second TAI list, and on which the SUB1 is camped. In some aspects, the UE may perform the cell reselection based at least in part on a threshold. For example, the UE may perform the cell reselection to the cell having TAC-3 if a measurement (e.g., an RSRP) of the cell satisfies a threshold (which may be configurable, and which may have a default value of, for example, −110 dBm), and if the cell is suitable for camping. For example, if SUB1 cannot find a target cell, then SUB2 may check the stored database and perform a force reselection to a target cell where a current TAC of SUB1 is a part of a TAI list of FR2 if the target cell's RSRP is greater than a threshold (Rsrp_thresh) and if the target cell is suitable for camping.

As indicated above, FIG. 8 is provided as an example. Other examples may differ from what is described with regard to FIG. 8.

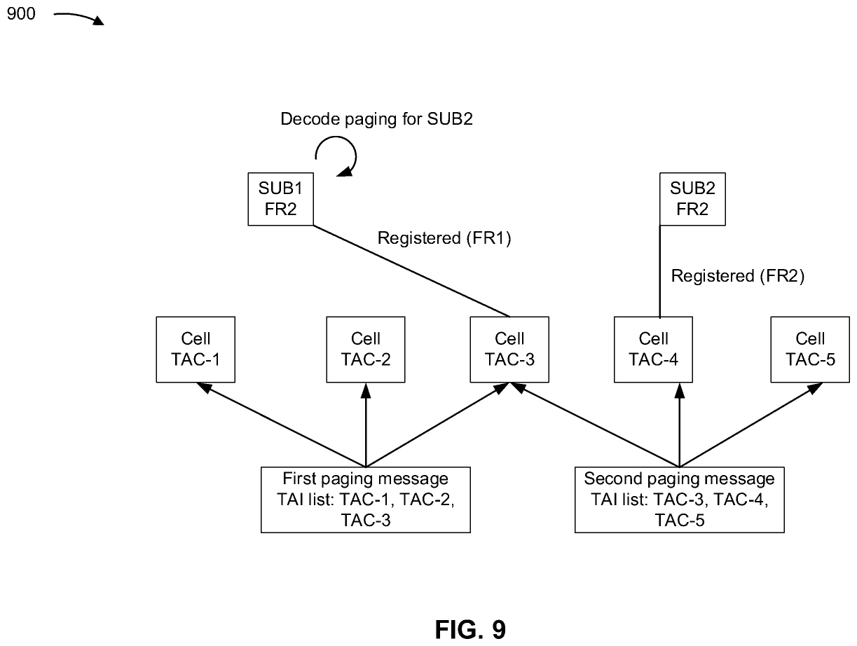

FIG. 9 is a diagram illustrating an example 900 of decoding paging for a first SUB and a second SUB associated with a same FR, in accordance with the present disclosure. In example 900, SUB1 and SUB2 are both camped on cells in FR2. For example, SUB1 may be camped on an FR2 cell having TAC-3, and SUB2 may be camped on any cell of a TAI list including TAC-3. In this example, SUB1 may decode paging for SUB2, even in situations where page sharing is not enabled (e.g., when SUB1 and SUB2 are associated with different operators, when SUB1 and SUB2 are associated with different dedicated priorities, or when SUB1 is a DDS and SUB2 is an nDDS in a connected mode). In such examples, SUB1 may decode paging for SUB2 if SUB1 can manage the UE 120's beam to decode paging of SUB2, and if a TAC on which SUB1 is camped is included in a TAI list of SUB2 (e.g., TAC-3). For example, the UE may receive the paging message using a beam associated with SUB2 (e.g., a beam configured for transmission in a direction facilitating reception of the paging message), which may be controlled by SUB1.

As indicated above, FIG. 9 is provided as an example. Other examples may differ from what is described with regard to FIG. 9.

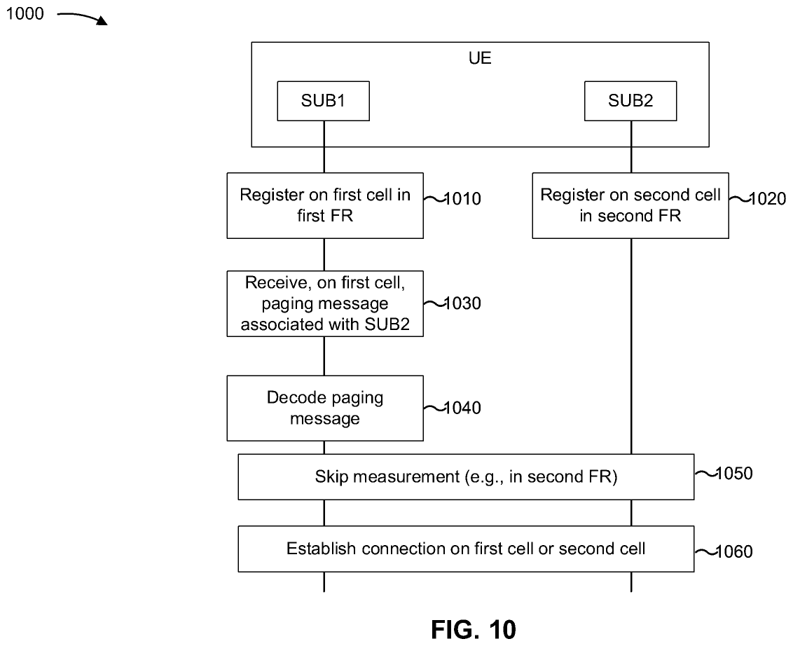

FIG. 10 is a diagram illustrating an example 1000 of signaling associated with decoding paging across multiple SUBs, in accordance with the present disclosure. Example 1000 includes a UE (e.g., UE 120) including SUB1 and SUB2, as described with regard to FIGS. 4-9. In some examples, example 1000 may incorporate any one or more operations described with regard to any one or more of FIGS. 4-8.

As shown by reference number 1010, SUB1 may register on a first cell in a first FR (e.g., FR1). In some aspects, SUB1 may camp on the first cell in the first FR. As shown by reference number 1020, SUB2 may register on a second cell in a second FR (e.g., FR2). For example, SUB2 may camp on the second cell in the second FR.

As shown by reference number 1030, the UE may receive, on the first cell and via SUB1, a paging message associated with SUB2. For example, the paging message may be associated with SUB2 because the paging message may be directed to a TAI list including a TAC of the second cell (that also includes a TAC of the first cell). As shown by reference number 1040, the UE may decode the paging message, as described with regard to FIGS. 6-9.

As shown by reference number 1050, in some aspects, the UE may skip a measurement (e.g., an idle mode measurement) in the second FR. For example, SUB2 may skip a measurement in the second FR. In some aspects, the UE may perform a subset of configured measurements in the second FR. For example, the UE may perform measurements in accordance with a configuration indicating a number of measurement occasions to skip. For example, instead of performing measurements on every discontinuous reception (DRX) cycle of the UE, the UE may perform measurements in every Xth DRX cycle. X may be configurable. In some aspects, a default value of X may be 4 (such that the UE performs idle-mode measurements, in the second FR, every 4^{th} DRX cycle of SUB2). Thus, the number of retunings to and from the second FR is reduced, thereby reducing power consumption and interruption of UE communications. In some aspects, SUB2 may receive a paging message on the second FR when performing measurements on the second FR, thereby conserving resources of SUB1 (since the UE is already tuned to the second FR for the measurements).

As shown by reference number 1060, the UE may establish a connection. For example, the UE may establish an RRC connection with a network node. In some aspects, the UE may establish the connection on the first cell (e.g., the FR1 cell). In some other aspects, the UE may establish the connection on the second cell (e.g., the FR2 cell). In some aspects, the UE may establish the connection on either of the first cell or the second cell, so long as the first cell and the second cell belong to a same TAI (e.g., TAC-3, in FIG. 6). In some aspects, the UE may select a cell of the first cell or the second cell on which to establish the connection. For example, the UE may select the cell according to a set of factors. The set of factors may include, for example, a cause (e.g., reason) of the connection establishment, an energy consumption associated with communication on the cell, a throughput of the cell or of a communication or service associated with the connection establishment, a quality of service (QOS) associated with the communication or service, or the like. For example, a voice call may be associated with a low throughput and a low QoS requirement. In this example, the UE may establish the connection on the first cell, since the first cell in the first FR can satisfy the throughput and QoS requirement of the voice call. In some aspects, the UE may establish the connection on the first cell irrespective of whether the paging message is directed to the first SUB or the second SUB.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with decoding paging.

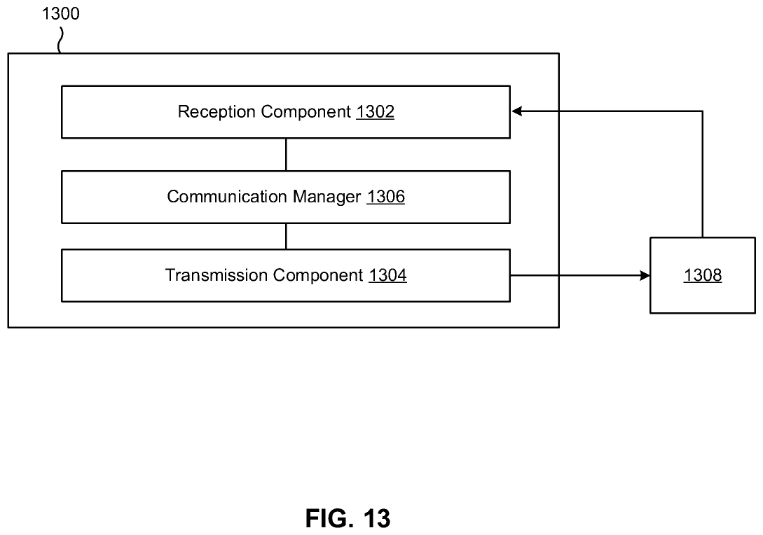

As shown in FIG. 11, in some aspects, process 1100 may include registering on a first cell, in a first frequency range, associated with a first subscription of the UE (block 1110). For example, the UE (e.g., using communication manager 1306, depicted in FIG. 13) may register on a first cell, in a first frequency range, associated with a first subscription of the UE, as described above.

As further shown in FIG. 11, in some aspects, process 1100 may include registering on a second cell, in a second frequency range, associated with a second subscription of the UE (block 1120). For example, the UE (e.g., using communication manager 1306, depicted in FIG. 13) may register on a second cell, in a second frequency range, associated with a second subscription of the UE, as described above.

As further shown in FIG. 11, in some aspects, process 1100 may include receiving, on the first cell and via the first subscription, a paging message associated with the second subscription (block 1130). For example, the UE (e.g., using reception component 1302 and/or communication manager 1306, depicted in FIG. 13) may receive, on the first cell and via the first subscription, a paging message associated with the second subscription, as described above.

As further shown in FIG. 11, in some aspects, process 1100 may include decoding the paging message (block 1140). For example, the UE (e.g., using communication manager 1306, depicted in FIG. 13) may decode the paging message, as described above.

Process 1100 may include additional aspects, such as any single aspect or any combination of aspects described below and/or in connection with one or more other processes described elsewhere herein.

In a first aspect, the decoding the paging message further comprises decoding the paging message in association with the first cell having a tracking area code that is included in a tracking area identity list of the second subscription.

In a second aspect, alone or in combination with the first aspect, process 1100 includes registering, prior to registering on the first cell, on a third cell, wherein a third tracking area code of the third cell is not included in a tracking area identity list of the second subscription, and reselecting, at the first subscription and prior to receiving the paging message, from the third cell to the first cell, wherein a first tracking area code of the first cell is included in the tracking area identity list of the second subscription.

In a third aspect, alone or in combination with one or more of the first and second aspects, process 1100 includes registering, at the second subscription and prior to registering on the second cell, on a third cell associated with a third tracking area identity list, wherein a first tracking area code of the first cell is not included in the third tracking area identity list, and reselecting, at the second subscription, from the third cell to the second cell, wherein the first tracking area code of the first cell is included in a second tracking area identity list, associated with the second cell, of the second subscription.

In a fourth aspect, alone or in combination with one or more of the first through third aspects, the first frequency range and the second frequency range are a same frequency range, and the reception of the paging message associated with the second subscription further comprises receiving the paging message using a beam associated with the second subscription.

In a fifth aspect, alone or in combination with one or more of the first through fourth aspects, the first subscription is associated with a first operator and the second subscription is associated with a second operator different from the first operator, or the first subscription is associated with a first dedicated priority and the second subscription is associated with a second dedicated priority different from the first dedicated priority, or the second subscription is in a connected mode.

In a sixth aspect, alone or in combination with one or more of the first through fifth aspects, process 1100 includes skipping, in association with the second subscription, a measurement in the second frequency range.

In a seventh aspect, alone or in combination with one or more of the first through sixth aspects, process 1100 includes performing, in association with the second subscription, the measurement in the second frequency range in accordance with a configuration indicating a number of measurement occasions to skip.

In an eighth aspect, alone or in combination with one or more of the first through seventh aspects, process 1100 includes establishing a connection on one of the first cell or the second cell.

In a ninth aspect, alone or in combination with one or more of the first through eighth aspects, the establishment of the connection on one of the first cell or the second cell is based at least in part on a set of factors.

In a tenth aspect, alone or in combination with one or more of the first through ninth aspects, the establishment of the connection on one of the first cell or the second cell further comprises establishing the connection on the first cell.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120) performs operations associated with techniques for decoding paging for millimeter wave capable UEs.

As shown in FIG. 12, in some aspects, process 1200 may include registering on a first cell in a first frequency range (block 1210). For example, the UE (e.g., using communication manager 1306, depicted in FIG. 13) may register on a first cell in a first frequency range (e.g., FR2), as described above.

As further shown in FIG. 12, in some aspects, process 1200 may include receiving, on the first cell, a paging message associated with a second cell and a second frequency range different from the first frequency range (block 1220). For example, the UE (e.g., using reception component 1302 and/or communication manager 1306, depicted in FIG. 13) may receive, on the first cell, a paging message associated with a second cell and a second frequency range (e.g., FR1) different from the first frequency range, as described above.

As further shown in FIG. 12, in some aspects, process 1200 may include decoding the paging message (block 1230). For example, the UE (e.g., using communication manager 1306, depicted in FIG. 13) may decode the paging message, as described above.

Process 1200 may include additional aspects, such as any single aspect or any combination of aspects described below and/or in connection with one or more other processes described elsewhere herein.

In a first aspect, the first cell is associated with a first tracking area code, the second cell is associated with a second tracking area code, and the first tracking area code and the second tracking area code are both identified by a tracking area identity list of the UE.

In a second aspect, alone or in combination with the first aspect, process 1200 includes skipping a measurement in the first frequency range.

In a third aspect, alone or in combination with one or more of the first and second aspects, process 1200 includes performing the measurement in the first frequency range in accordance with a configuration indicating a number of measurement occasions to skip.

In a fourth aspect, alone or in combination with one or more of the first through third aspects, process 1200 includes establishing a connection on one of the first cell or the second cell.

In a fifth aspect, alone or in combination with one or more of the first through fourth aspects, the establishment of the connection on one of the first cell or the second cell is based at least in part on a set of factors.

In a sixth aspect, alone or in combination with one or more of the first through fifth aspects, the establishment of the connection on one of the first cell or the second cell further comprises establishing the connection on the first cell.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-11. Additionally, or alternatively, the apparatus 1300 may be configured to perform one or more processes described herein, such as process 1100 of FIG. 11, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may register on a first cell, in a first frequency range, associated with a first subscription of the UE. The communication manager 1306 may register on a second cell, in a second frequency range, associated with a second subscription of the UE. The reception component 1302 may receive, on the first cell and via the first subscription, a paging message associated with the second subscription. The communication manager 1306 may decode the paging message.

The communication manager 1306 may register, prior to registering on the first cell, on a third cell, wherein a third tracking area code of the third cell is not included in a tracking area identity list of the second subscription, and reselect, at the first subscription and prior to receiving the paging message, from the third cell to the first cell, wherein a first tracking area code of the first cell is included in the tracking area identity list of the second subscription.

The communication manager 1306 may register, at the second subscription and prior to registering on the second cell, on a third cell associated with a third tracking area identity list, wherein a first tracking area code of the first cell is not included in the third tracking area identity list, and reselect, at the second subscription, from the third cell to the second cell, wherein the first tracking area code of the first cell is included in a second tracking area identity list, associated with the second cell, of the second subscription.

The communication manager 1306 may skip, in association with the second subscription, a measurement in the second frequency range.

The communication manager 1306 may perform, in association with the second subscription, the measurement in the second frequency range in accordance with a configuration indicating a number of measurement occasions to skip.

The communication manager 1306 may establish a connection on one of the first cell or the second cell.

The communication manager 1306 may register on a first cell in a first frequency range. The reception component 1302 may receive, on the first cell, a paging message associated with a second cell and a second frequency range different from the first frequency range. The communication manager 1306 may decode the paging message.

The communication manager 1306 may skip a measurement in the first frequency range.

The communication manager 1306 may perform the measurement in the first frequency range in accordance with a configuration indicating a number of measurement occasions to skip.

The communication manager 1306 may establish a connection on one of the first cell or the second cell.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: registering on a first cell, in a first frequency range, associated with a first subscription of the UE; registering on a second cell, in a second frequency range, associated with a second subscription of the UE; receiving, on the first cell and via the first subscription, a paging message associated with the second subscription; and decoding the paging message.

Aspect 2: The method of Aspect 1, wherein the decoding the paging message further comprises decoding the paging message in association with the first cell having a tracking area code that is included in a tracking area identity list of the second subscription.

Aspect 3: The method of any of Aspects 1-2, further comprising registering, prior to registering on the first cell, on a third cell, wherein a third tracking area code of the third cell is not included in a tracking area identity list of the second subscription; and reselecting, at the first subscription and prior to receiving the paging message, from the third cell to the first cell, wherein a first tracking area code of the first cell is included in the tracking area identity list of the second subscription.

Aspect 4: The method of any of Aspects 1-3, further comprising registering, at the second subscription and prior to registering on the second cell, on a third cell associated with a third tracking area identity list, wherein a first tracking area code of the first cell is not included in the third tracking area identity list, and reselecting, at the second subscription, from the third cell to the second cell, wherein the first tracking area code of the first cell is included in a second tracking area identity list, associated with the second cell, of the second subscription.

Aspect 5: The method of any of Aspects 1-4, wherein the first frequency range and the second frequency range are a same frequency range, and wherein the reception of the paging message associated with the second subscription further comprises receiving the paging message using a beam associated with the second subscription.

Aspect 6: The method of Aspect 5, wherein the first subscription is associated with a first operator and the second subscription is associated with a second operator different from the first operator, or the first subscription is associated with a first dedicated priority and the second subscription is associated with a second dedicated priority different from the first dedicated priority, or the second subscription is in a connected mode.

Aspect 7: The method of any of Aspects 1-6, further comprising skipping, in association with the second subscription, a measurement in the second frequency range.

Aspect 8: The method of Aspect 7, further comprising performing, in association with the second subscription, the measurement in the second frequency range in accordance with a configuration indicating a number of measurement occasions to skip.

Aspect 9: The method of any of Aspects 1-8, further comprising establishing a connection on one of the first cell or the second cell.

Aspect 10: The method of Aspect 9, wherein the establishment of the connection on one of the first cell or the second cell is based at least in part on a set of factors.

Aspect 11: The method of Aspect 9, wherein the establishment of the connection on one of the first cell or the second cell further comprises establishing the connection on the first cell.

Aspect 12: A method of wireless communication performed by a user equipment (UE), comprising: registering on a first cell in a first frequency range; receiving, on the first cell, a paging message associated with a second cell and a second frequency range different from the first frequency range; and decoding the paging message.

Aspect 13: The method of Aspect 12, wherein the first cell is associated with a first tracking area code, the second cell is associated with a second tracking area code, and the first tracking area code and the second tracking area code are both identified by a tracking area identity list of the UE.

Aspect 14: The method of any of Aspects 12-13, further comprising skipping a measurement in the first frequency range.

Aspect 15: The method of Aspect 14, further comprising performing the measurement in the first frequency range in accordance with a configuration indicating a number of measurement occasions to skip.

Aspect 16: The method of any of Aspects 12-15, further comprising establishing a connection on one of the first cell or the second cell.

Aspect 17: The method of Aspect 16, wherein the establishment of the connection on one of the first cell or the second cell is based at least in part on a set of factors.

Aspect 18: The method of Aspect 16, wherein the establishment of the connection on one of the first cell or the second cell further comprises establishing the connection on the first cell.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers.

Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous.

Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A user equipment (UE) for wireless communication, comprising:
one or more memories; and
one or more processors, coupled to the one or more memories, configured to:
register on a first cell, in a first frequency range, associated with a first subscription of the UE;
register on a second cell, in a second frequency range, associated with a second subscription of the UE;
receive, on the first cell and via the first subscription, a paging message associated with the second subscription; and
decode the paging message.

2. The UE of claim 1, wherein the one or more processors, to decode the paging message, are configured to decode the paging message in association with the first cell having a tracking area code that is included in a tracking area identity list of the second subscription.

3. The UE of claim 1, wherein the one or more processors are further configured to register, prior to registering on the first cell, on a third cell, wherein a third tracking area code of the third cell is not included in a tracking area identity list of the second subscription; and
reselect, at the first subscription and prior to receiving the paging message, from the third cell to the first cell, wherein a first tracking area code of the first cell is included in the tracking area identity list of the second subscription.

4. The UE of claim 1, wherein the one or more processors are further configured to register, at the second subscription and prior to registering on the second cell, on a third cell associated with a third tracking area identity list, wherein a first tracking area code of the first cell is not included in the third tracking area identity list; and
reselect, at the second subscription, from the third cell to the second cell, wherein the first tracking area code of the first cell is included in a second tracking area identity list, associated with the second cell, of the second subscription.

5. The UE of claim 1, wherein the first frequency range and the second frequency range are a same frequency range, and wherein the one or more processors, to receive the paging message associated with the second subscription, are configured to receive the paging message using a beam associated with the second subscription.

6. The UE of claim 5, wherein the first subscription is associated with a first operator and the second subscription is associated with a second operator different from the first operator, or
the first subscription is associated with a first dedicated priority and the second subscription is associated with a second dedicated priority different from the first dedicated priority, or
the second subscription is in a connected mode.

7. The UE of claim 1, wherein the one or more processors are further configured to skip, in association with the second subscription, a measurement in the second frequency range.

8. The UE of claim 7, wherein the one or more processors are further configured to perform, in association with the second subscription, the measurement in the second frequency range in accordance with a configuration indicating a number of measurement occasions to skip.

9. The UE of claim 1, wherein the one or more processors are further configured to establish a connection on one of the first cell or the second cell.

10. The UE of claim 9, wherein the establishment of the connection on one of the first cell or the second cell is based at least in part on a set of factors.

11. The UE of claim 9, wherein the one or more processors, to establish the connection on one of the first cell or the second cell, are further configured to establish the connection on the first cell.

12. A user equipment (UE) for wireless communication, comprising:
one or more memories; and
one or more processors, coupled to the one or more memories, configured to:
register on a first cell in a first frequency range;
receive, on the first cell, a paging message associated with a second cell and a second frequency range different from the first frequency range; and
decode the paging message.

13. The UE of claim 12, wherein the first cell is associated with a first tracking area code, the second cell is associated with a second tracking area code, and the first tracking area code and the second tracking area code are both identified by a tracking area identity list of the UE.

14. The UE of claim 12, wherein the one or more processors are further configured to skip a measurement in the first frequency range.

15. The UE of claim 14, wherein the one or more processors are further configured to perform the measurement in the first frequency range in accordance with a configuration indicating a number of measurement occasions to skip.

16. The UE of claim 12, wherein the one or more processors are further configured to establish a connection on one of the first cell or the second cell.

17. The UE of claim 16, wherein the establishment of the connection on one of the first cell or the second cell is based at least in part on a set of factors.

18. The UE of claim 16, wherein the one or more processors, to establish the connection on one of the first cell or the second cell, are configured to establish the connection on the first cell.

19. A method of wireless communication performed by a user equipment (UE), comprising:
registering on a first cell, in a first frequency range, associated with a first subscription of the UE;
registering on a second cell, in a second frequency range, associated with a second subscription of the UE;
receiving, on the first cell and via the first subscription, a paging message associated with the second subscription; and
decoding the paging message.

20. The method of claim 19, wherein the decoding the paging message further comprises decoding the paging message in association with the first cell having a tracking area code that is included in a tracking area identity list of the second subscription.

21-30. (canceled)
